(19) United States
(12) Patent Application Publication
(10) Pub. No.: US 2025/0030822 A1
(43) Pub. Date: Jan. 23, 2025

(54) ELECTRONIC DEVICE, PROJECTION SYSTEM, AND PROJECTION METHOD THEREOF

(71) Applicant: Coretronic Corporation, Hsin-Chu (TW)

(72) Inventors: Ssu-Ming Chen, Hsin-Chu (TW); Yu-Meng Chen, Hsin-Chu (TW); Wei-Wei Yin, Hsin-Chu (TW)

(73) Assignee: Coretronic Corporation, Hsin-Chu (TW)

(21) Appl. No.: 18/774,892

(22) Filed: Jul. 16, 2024

(30) Foreign Application Priority Data
Jul. 18, 2023 (CN) 202310877276.7

(51) Int. Cl. H04N 9/31; G06T 7/11; G06T 7/194; G06T 7/564; G06T 7/73

(52) U.S. Cl. CPC H04N 9/3185; G06T 7/11; G06T 7/194; G06T 7/564; G06T 7/73; G06T 2207/30204

(57) ABSTRACT

An electronic device, projection system, and projection method are provided. The electronic device is communicatively coupled to the projection device. The electronic device includes a camera, a memory and a processor. The memory stores an application. The processor is coupled to the camera and the memory. The processor is configured to execute the following steps of the application: controlling the projection device to project a marked image having a plurality of predetermined marks to a target area; controlling the camera to take a first image of the target area, wherein the first image comprises a foreground object and a background object of the target area; analyzing the first image, to obtain a foreground contour corresponding to the foreground object; and overlaying a selected pattern onto the foreground contour to generate a second image, and controlling the projection device to project the second image to the target area.

### CROSS-REFERENCE TO RELATED APPLICATION

This application claims the priority benefit of China application no. 202310877276.7, filed on Jul. 18, 2023. The entirety of each of the above mentioned patent applications is hereby incorporated by reference herein and made a part of this specification.

### BACKGROUND

### 1. Technical Field

The present disclosure is related to a device, system and method, and more particularly, to an electronic device, projection system and projection method thereof.

### 2. Description of Related Art

In projection mapping, a projection device is used to project an image onto the surface of an object, and the projected image usually fits or adapts to the direction of the object surface, thereby creating various visual effects.

However, to establish projection mapping, special equipment is currently required, along with cumbersome operations and control procedures. These cumbersome procedures require professional setup companies to set up according to the environmental conditions, and further require professional projection devices, peripheral equipment, audio and video editing, etc., In particular, audio and video editing are usually required to be produced by professional audio and video production companies based on occasions and environments of the projection mapping. These requirements stop normal users from performing the projection mapping at home or going out anytime.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The present disclosure provides an electronic device, a projection system, a projection method thereof, which elevates the convenience of projection mapping. Other objectives and advantages of the present disclosure may be further understood from the disclosed technical details of the present disclosure.

To achieve part of or all aforementioned or other objectives, the electronic device of the present disclosure is communicatively coupled to the projection device. The electronic device includes a camera, a memory and a processor. The memory stores an application. The processor is coupled to the camera and the memory. The processor is configured to execute the following steps of the application: controlling the projection device to project a marked image having a plurality of predetermined marks to a target area; controlling the camera to take a first image of the target area, wherein the first image comprises a foreground object and a background object of the target area; analyzing the first image, to obtain a foreground contour corresponding to the foreground object; and overlaying a selected pattern onto the foreground contour to generate a second image, and controlling the projection device to project the second image to the target area.

To achieve part of or all aforementioned or other objectives, the projection system of the present disclosure includes a projection device and an electronic device. The projection device comprises a camera and a first processor. The camera takes a first image of the target area, wherein the first image comprises a depth information of a foreground object and a background object in the target area. The first processor is configured to receive the first image, and obtain a foreground contour corresponding to the foreground object through analyzing the depth information of the first image. The electronic device is communicatively coupled to the projection device, the electronic device comprises a second processor, and configured to execute: overlaying a selected pattern onto the foreground contour to generate a second image, and providing the second image to the projection device, allowing the projection device to project the second image to the target area.

To achieve part of or all aforementioned or other objectives, the projection method of the present disclosure is configured to control a projection device. The projection method includes: controlling the projection device to project a marked image having a plurality of predetermined marks to a target area; taking a first image of the target area, wherein the first image comprises a foreground object and a background object in the target area; analyzing the first image to obtain a foreground contour corresponding to the foreground object; and overlaying a selected pattern onto the foreground contour to generate a second image, and controlling the projection device to project the second image to the target area.

To achieve part of or all aforementioned or other objectives, the projection method of the present disclosure is configured to control a projection system. The projection system includes a projection device and an electronic device. The projection device includes a camera and a first processor. The projection method includes: taking a first image of the target area through the camera of the projection device, wherein the first image comprises a depth information of a foreground object and a background object in the target area; obtaining and analyzing the first image through the first processor, to obtain a foreground contour corresponding to the foreground object according to the depth information of the first image; and overlaying a selected pattern onto the foreground contour to generate a second image through the electronic device, and providing the second image to the projection device, allowing the projection device to project the second image to the target area.

Based on the above, the electronic device, projection system and projection method of the present disclosure may simply identify the foreground object in the target area, and overlay the selected pattern onto the foreground contour corresponding to the foreground object and project it, effectively improving convenience of the projection mapping system.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of an electronic device and a projection device according to an embodiment of the present disclosure.

FIG. 2 is a flow chart of a projection method according to an embodiment of the present disclosure.

FIG. 3A is a schematic diagram of a marked image according to an embodiment of the present disclosure.

FIG. 3B is a schematic diagram of a first image of the embodiment of the present disclosure.

FIG. 3C is a schematic diagram of a selected pattern overlaid onto the foreground contour according to an embodiment of the present disclosure.

FIG. 3D is a schematic diagram of a second image projected on a target area according to an embodiment of the present disclosure.

FIGS. 4A-4C illustrate the operation process of the electronic device executing the application to determine the selected pattern according to an embodiment of the present disclosure.

FIG. 5 is a block diagram of a projection system according to an embodiment of the present disclosure.

FIG. 6 is a flow chart of a projection method according to an embodiment of the present disclosure.

FIG. 7A is a schematic diagram of a first image according to an embodiment of the present disclosure.

FIG. 7B is a schematic diagram of a foreground contour according to an embodiment of the present disclosure.

FIG. 7C illustrates a schematic diagram of a selected pattern overlaid onto the foreground contour according to an embodiment of the present disclosure.

FIG. 7D illustrates a second image projected to a target area according to an embodiment of the present disclosure.

### DESCRIPTION OF THE EMBODIMENTS

It is to be understood that other embodiment may be utilized and structural changes may be made without departing from the scope of the present disclosure. Also, it is to be understood that the phraseology and terminology used herein are for the purpose of description and should not be regarded as limiting. The use of “including,” “comprising.” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The foregoing and other technical contents, features and effects of the present disclosure will be clearly presented in the following detailed description of a preferred embodiment with reference to the drawings. The direction terms mentioned in the following embodiments, for example: up, down, left, right, front or back, etc., are only for reference to the direction of the attached drawings. Therefore, the direction terms used are for illustration and not for limiting the present disclosure.

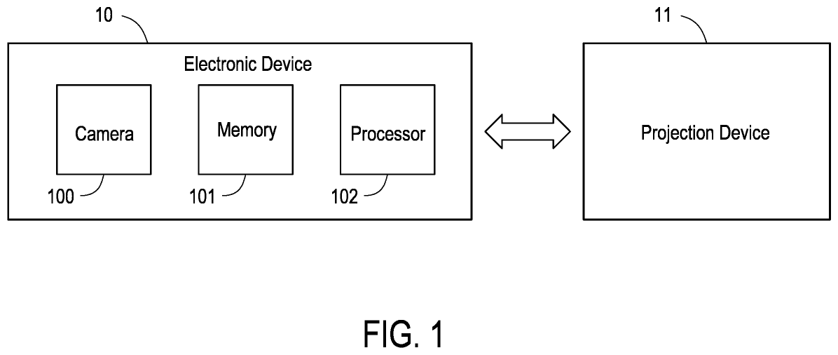

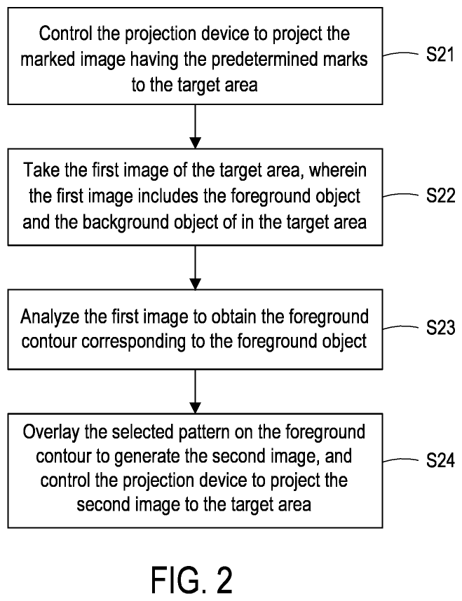

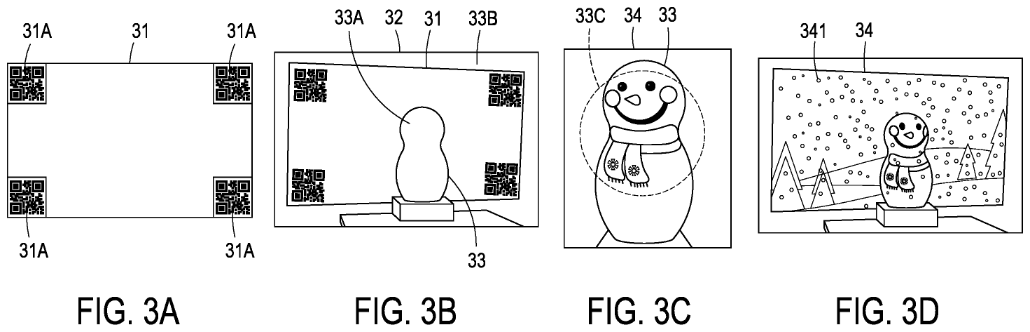

FIG. 1 is a schematic diagram of an electronic device 10 and a projection device 11 according to an embodiment of the present disclosure. FIG. 2 is a flow chart of a projection method according to an embodiment of the present disclosure. FIG. 3A is a schematic diagram of a marked image 31 according to an embodiment of the present disclosure. FIG. 3B is a schematic diagram of a first image 32 of the embodiment of the present disclosure. FIG. 3C is a schematic diagram of a selected pattern overlaid onto the foreground contour 33 according to an embodiment of the present disclosure. FIG. 3D is a schematic diagram of a second image 34 projected on a target area according to an embodiment of the present disclosure. Please refer to FIG. 1 first. The electronic device 10 is communicatively coupled to the projection device 11 to control projection of the projection device 11 and adjust a projection image of the projection device 11. The electronic device 10 includes a camera 100, a memory 101, and a processor 102. The camera 100 may be configured to capture images. The memory 101 stores an application. The processor 102, coupled to the camera 100 and the memory 101, may access the memory 101 to execute the application. Please refer to FIG. 1 together with FIGS. 3A-3D. The processor 102 may execute the application to control the projection device 11 for projecting a marked image 31 having a plurality of predetermined marks 31A to the target area; control the camera 100 to take the first image 32 of the target area, wherein the first image 32 includes a foreground object 33A and a background object 33B in the target area, wherein the background object 33B may refers to, for example, a projection screen or a wall; analyze the first image 32 to obtain a foreground contour 33 corresponding to the foreground object 33A; and overlay a selected pattern 33C onto the foreground contour 33 to generate a second image 34, and control the projection device to project the second image 34 to the target area as shown in FIG. 3D. In this embodiment, the second image 34 presented in FIG. 3D also includes a selected background 341. Notably, before the processor 102 overlays the selected pattern 33C onto the foreground contour 33 to generate the second image 34 as shown in FIG. 3D, the processor 102 will overlay the foreground contour 33 on the selected background 341 first, and then overlay the selected pattern 33C on a position of the foreground contour 33 to generate the effect of the second image 34 as shown in FIG. 3D. In some embodiments, a user may choose whether to display the selected background 341 or not. For example, on the display image of the electronic device 10, there is an option (not illustrated) of whether to display the selected background 341. If the user chooses to display selected background 341, it will be displayed as shown in FIG. 3D; if the user does not choose to display the selected background 341, it will only be displayed with the target area as shown in FIG. 3C, without the selected background 341.

In brief, the electronic device 10 may determine the foreground contour 33 corresponding to the foreground object 33A by taking the first image 32 having the marked image 31. Further, the electronic device 10 may, by executing the application, provide the selected background 341 to overlay the foreground contour 33 onto the selected background 341 first, and then overlay the appropriate selected pattern 33C onto the foreground contour 33 to generate the second image 34, and control the projection device 11 to project the second image 34, thereby making the selected pattern 33C to be appropriately projected onto the foreground object 33A. The selected background 341 may be selected by the user to present the projection effect of the scene, or without using the selected background 341 to only display the selected pattern 33C overlaid onto the foreground contour 33.

Specifically, the electronic device 10 may be, for example but not limited to, a mobile phone, a mobile station, an advanced mobile station (AMS), a server, a client device, a desktop computer, a notebook computer, a network mobile computer, a workstation, a personal digital assistant (PDA), a personal computer (PC), a tablet computer, a scanner, a telephone device, a television, a handheld game console, a music device, a wireless sensor, etc., or other suitable electronic devices. The electronic device 10 may be communicatively coupled to the projection device 11 through wired or wireless connections, thereby transmitting images with the projection device 11 and controlling the projection of the projection device 11.

In some embodiments, memory 101 may be, for example but not limited to, any type of fixed or removable random access memories (RAM), read-only memories (ROM), flash memories (Flash Memory), hard disk drives (HDD), solid state drives (SSD) or similar components or a combination of the above, used to store applications or instructions that may be executed by the processor 102. The processor 102 is coupled to the camera 100 and the memory 101, and is communicatively coupled to the projection device 11. Specifically, the processor 102 may execute the application by controlling the camera 100 and projection device 11. In some embodiments, the processor 102 may be, for example but not limited to, a central processing unit (CPU), or other general-purpose or specific-purpose programmable micro control units (MCU), a microprocessor, a digital signal processor (DSP), a programmable controller, an application specific integrated circuit (ASIC), a graphics processing unit (GPU), an arithmetic logic unit (ALU), a complex programmable logic device (CPLD), a field programmable gate array (FPGA), or any other kinds of integrated circuits, state machines, or processors based on the advanced RISC machine (ARM), or other similar components or combinations of the above. Alternatively, the processor 102 may be a hardware circuit designed and realized using a hardware description language (HDL) or any other digital circuits well known to those skilled in the art.

Please refer to FIGS. 3A-3D again together with the flowchart in FIG. 2. The projection method may be performed by the electronic device 10 in FIG. 1. The projection method in FIG. 2 includes steps S21-S24. In step S21, the electronic device 10 may control the projection device 11 to project the marked image 31 having the predetermined marks 31A to the target area. In step S22, the electronic device 10 may use the camera 100 to take the first image 32 of the target area, wherein the first image 32 includes the foreground object 33A and background object 33B in the target area. In step S23, the electronic device 10 may analyze the first image 32 to obtain the foreground contour 33 corresponding to the foreground object 33A. In step S24, the electronic device 10 may overlay the selected pattern 33C onto the foreground contour 33 to generate the second image 34, and control the projection device to project the second image 34 to the target area.

In the following paragraph about the electronic device 10 executing the projection method in FIG. 2, please refer to the schematic diagrams in FIGS. 3A-3D to better understand the operation details of the projection method.

Operations of step S21 will be explained together with FIG. 3A. First, in step S21, when the electronic device 10 starts to execute the application, the electronic device 10 may control the projection device 11 to project, such as, the marked image 31 as shown in FIG. 3A. Particularly, the marked image 31 has at least two predetermined marks 31A, which are distributed at least two corner positions on the marked image 31. In this embodiment, the marked image 31 has four predetermined marks 31A of QR codes, which are respectively distributed at four corner positions of the marked image 31. The projection device 11 may receive control from the electronic device to project the marked image 31 to the target area.

The operation of step S22 will be explained together with FIG. 3B. In step S22, the processor 102 of the electronic device 10 may control the camera 100 to take the first image 32 of the target area. Particularly, the marked image 31 is projected by the projection device 11 to a target area having a foreground object 33A (e.g., a snowman doll) and a background object 33B (e.g., a wall or a screen). The first image 32 taken by the electronic device 10 may include the complete marked image 31 projected to the target area.

The operation of step S23 will be explained together with FIGS. 3B-3C. In step S23, the processor 102 of the electronic device 10 will analyze the first image 32 to obtain the foreground contour 33 of the foreground object 33A in the first image 32. More particularly, the processor 102 will remove the background object 33B in the first image 32 to obtain a coordinate trajectory of the foreground contour 33 corresponding to the foreground object 33A in the first image 32.

In some embodiments, after the processor 102 determines the foreground contour 33, the application executed by the electronic device 10 may overlay the selected pattern 33C onto the foreground contour 33 of the first image 32, and display it on the screen of the electronic device to generate the image effect as shown in FIG. 3C. In other words, the electronic device 10 may overlay the selected pattern 33C onto the foreground contour 33 of the first image 32, thereby providing the user with a preview of how it looks of the selected pattern 33C projected onto the foreground object.

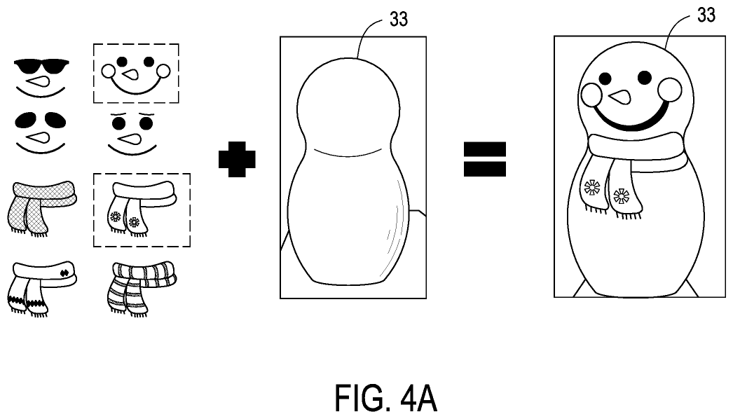

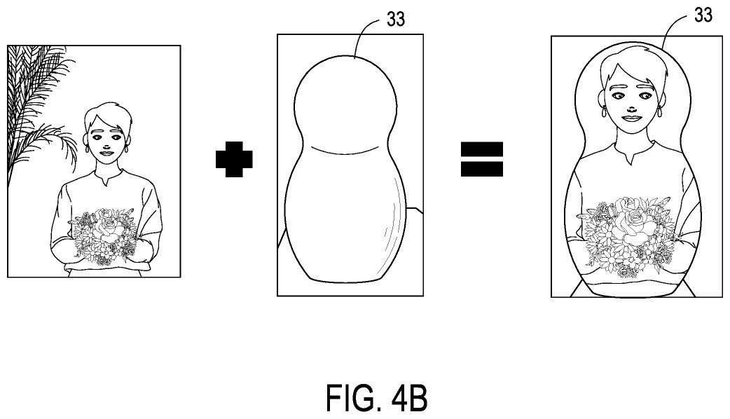

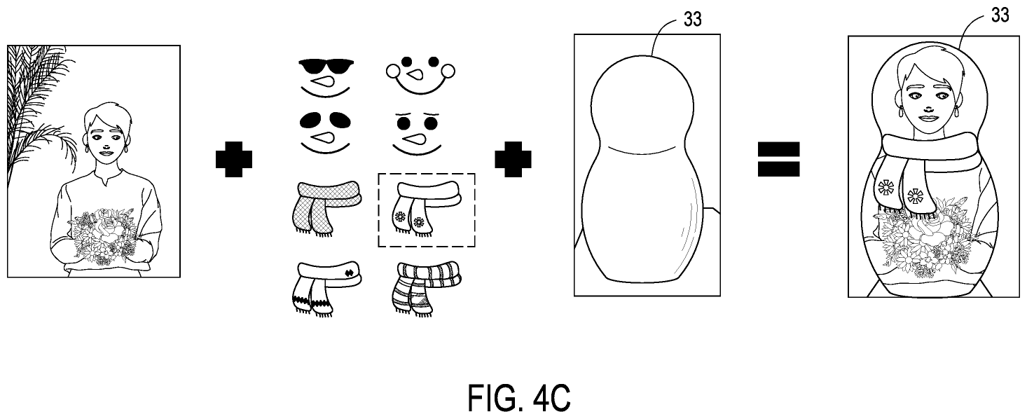

Regarding the operations of the electronic device 10 executing the application to determine the selected pattern, please refer together with FIGS. 3C and 4A-4C to better understand the following paragraphs. FIGS. 4A-4C illustrate the operation process of the electronic device executing the application to determine the selected pattern according to an embodiment of the present disclosure. The memory 101 of the electronic device 10 may store a plurality of patterns for selection (for example, expression patterns for selection and accessory patterns for selection shown on the left side in FIG. 4A), or the electronic device 10 may be communicatively coupled to a cloud server, from which the device may download the plurality of patterns for selection to the memory 101 of the electronic device 10. The electronic device 10 may receive a user input or automatically select a pattern from the patterns for selection as the selected pattern, and scale a size of the selected pattern according to the size of coordinate trajectory of the foreground contour 33 in the middle of FIG. 4A, and finally overlay the selected pattern onto the foreground contour 33 in the first image 32 offering preview for users. In addition, FIG. 4B provides a similar decision-making process of the selected pattern, except that the patterns for selection provided on the left side of FIG. 4B are a portrait pattern. Finally, FIG. 4C combines the decision-making processes of the selected patterns in FIGS. 4A and 4B. FIG. 4C on left side provides the portrait pattern, expression patterns for selection, and accessory patterns for selections. FIG. 4C on right side shows a visual effect of these selected patterns scaled to the same size as the foreground contour 33, and then overlaid onto the foreground contour 33. Therefore, the application executed by the electronic device 10 may provide the user with a realistic projection effect experience in advance, for determining the appropriate selected pattern.

In some embodiments, when the processor 102 executes the application, the processor 102 provides the selected background 341, and then overlays the foreground contour 33 onto the selected background 341. When the selected pattern (e.g., the selected pattern 33C in FIG. 3C) is decided by the user, the selected pattern 33C will not only be displayed on the electronic device 10, the projection device 1I will also project the second image 34 having the selected background 341 and selected pattern 33C to the target area at the same time. In this way, the user may modify and adjust the size and the position of the selected background 341 and selected pattern 33C on the screen of the electronic device 10 (as shown in FIG. 3C) by observing the visual effect projected to the target area by the projection device 11 (as shown in FIG. 3D).

Please continue to refer to FIGS. 3B-3D. In some usage scenarios, a shooting direction of the electronic device 10 and a projection direction of the projection device 11 may be the same or similar, and a shooting range of the first image 32 shot by the electronic device 10 may also be the same or similar to a projection range of the second image 34 projected by the projection device 11. In this way, the processor 102 may identify and take the coordinate trajectory of the foreground contour 33 in the first image 32 directly as the foreground contour in the second image 34 projected by the projection device 11, and the selected pattern 33 displayed on the electronic device 10 and the selected pattern projected to the target area by the projection device 11 will have the same position and coordinate relationship respectively in the first image 32 and second image 34. Therefore, the processor 102 may overlay the selected pattern 33C onto the foreground contour 33 to generate a second image 34 with the selected pattern 33C.

As shown in FIGS. 3B-3D, in some usage scenarios, the shooting direction of the electronic device 10 and the projection direction of the projection device 11 may have a deviation angle greater than a preset angle. In this way, there is a certain degree of deviation in the angle between the shooting range of the first image 32 taken by the electronic device 10 and the projection range of the second image 34 projected by the projection device 11. Therefore, the foreground contour 33 in the first image 32 taken by the electronic device 10 requires correction to show the foreground contour actually in the second image 34 projected by the projection device 11.

More specifically, please refer to FIGS. 3A-3D again. The processor 102 may determine the relative relationship between the first image 32 and the second image 34, and then converts the foreground contour 33 in the first image 32 in FIG. 3B to the foreground contour in the second image 34 in FIG. 3D accordingly. Particularly, the processor 102 may determine the projection range of the marked image 31 projected in the target area by identifying the position or coordinates of the predetermined marks 31A captured in the first image 32, and then determine an image range conversion relationship between the second image 34 and the first image 32. Then, according to the image range conversion relationship between the second image 34 and the first image 32, the processor 102 may convert the coordinate trajectory of the foreground contour 33 in the first image 32 into the coordinate trajectory of the foreground contour in the second image 34. Finally, the processor 102 overlays the selected pattern 33C onto the foreground contour 33, so that the foreground contour is shown in the selected pattern of the second image 34.

In addition, when the user adjusts the selected pattern 33C by operating the electronic device 10, since the second image 34 with the selected pattern is projected by the projection device 11, the adjustments (such as scaling, adjusting position, adjusting transparency, adjusting color, etc.) done on the electronic device 10 to the selected pattern 33C will be updated simultaneously to the second image 34 projected by the projection device 11, providing visual feedback for the user in real-time.

The operation of step S24 will be explained together with FIG. 3D. In step S24, the processor 102 of the electronic device 10 may control the projection device 11 to project the second image 34 to the target area. Particularly, when the second image 34 is projected to the target area by the projection device 11, the foreground contour 33 in the second image 34 will correspond to the foreground object 33A in the target area, so that the projected selected pattern 33C is exactly projected onto the foreground object 33A

In some embodiments, the processor 102 may obtain a plurality of backgrounds for selection by accessing the memory 101 or the cloud server, and the processor 102 may select the selected background 341 from these backgrounds for selection automatically or through user input. In this embodiment, the selected background 341 in the second image 34 is, for example, a snowing scene, and after the selected background 341 is selected, the foreground contour 33 is overlaid on the selected background 341, and the selected pattern 33C may be overlaid onto the foreground contour 33 to generate the second image 34.

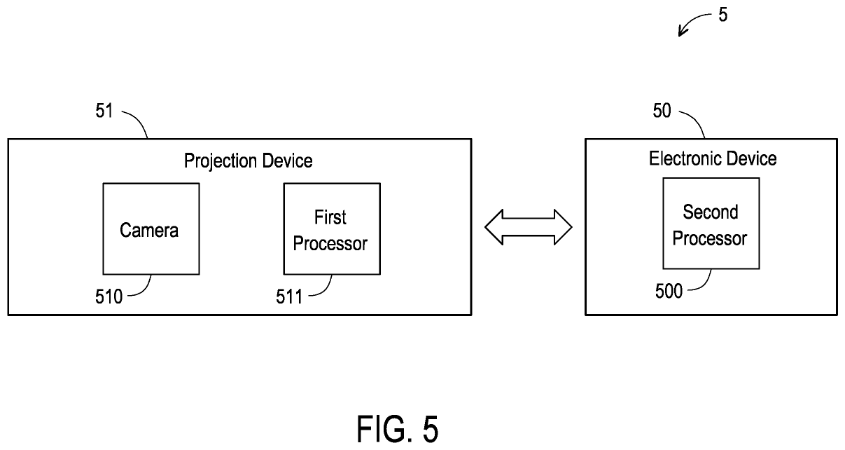

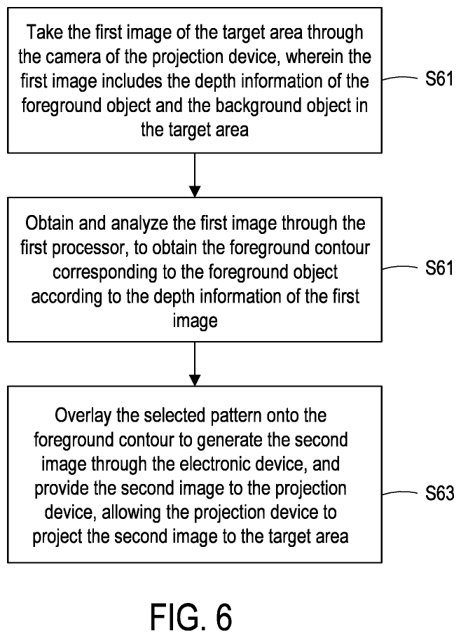

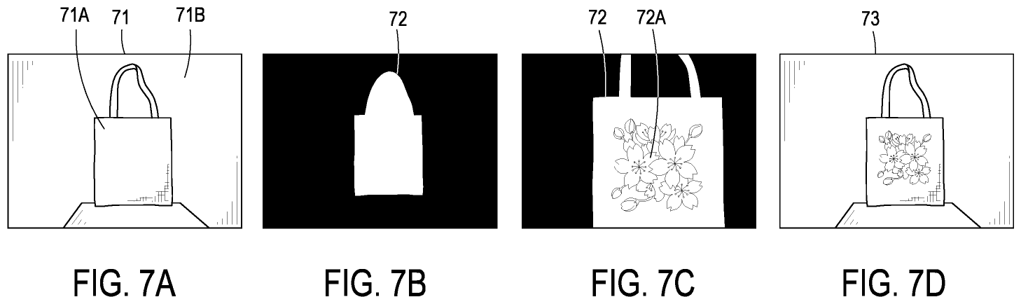

FIG. 5 is a block diagram of a projection system 5 according to an embodiment of the present disclosure. FIG. 6 is a flow chart of a projection method according to an embodiment of the present disclosure. FIG. 7A is a schematic diagram of a first image according to an embodiment of the present disclosure. FIG. 7B is a schematic diagram of a foreground contour according to an embodiment of the present disclosure. FIG. 7C illustrates a schematic diagram of a selected pattern overlaid onto the foreground contour according to an embodiment of the present disclosure. FIG. 7D illustrates a second image projected to a target area according to an embodiment of the present disclosure. Please refer to FIG. 5 first. The projection system 5 includes an electronic device 50 and a projection device 51. The electronic device 50 is communicatively coupled to the projection device 51. The projection device 51 includes a camera 510 and a first processor 511. The electronic device 50 includes a second processor 500. In brief, although not illustrated, the electronic device 50 includes a memory for storing the application. The second processor 500 coupled to the memory is may be utilized for executing the application through accessing the application. Please refer to FIG. 5 together with FIGS. 7A-7D. The second processor 500 may execute the application and control the projection device 51 to perform the following steps: controlling the camera 510 of the projection device 511 to take the first image 71 of the target area, wherein the first image 71 includes a depth information of the foreground object 71A and the background object 71B in the target area; and receiving the first image 71 by the first processor 511, and analyzing the depth information of the first image 71 to obtain the foreground contour 72 corresponding to foreground object 71A. Then, the second processor 500 may overlay the selected pattern 72A onto the foreground contour 72 to generate the second image 73, and provide the second image 73 to the projection device 51, so that the projection device 51 projects the second image 73 to the target area as shown in FIG. 7D.

Specifically, the electronic device 50 may be, for example but not limited to, a mobile phone, a mobile station, an AMS, a server, a client, a desktop computer, a notebook computer, a network mobile computer, a workstation, a PDA, a PC, a tablet computer, a scanner, a telephone device, a television, a handheld game console, a music device, a wireless sensor, etc., or other suitable electronic devices. The electronic device 50 may be communicatively coupled to the projection device 51 through wired or wireless connections, thereby transmitting images with the projection device 51 and controlling the projection operation of the projection device 51.

In some embodiments, the camera 510 may be, for example, a 3D camera, a ToF camera, a camera of structured light, a camera with dual-lens camera, or other suitable cameras capable of taking images with a depth information, so the camera 510 may obtain the depth information of the objects through taking images, thereby generating the first image with the depth information.

In some embodiments, the first processor 511 and the second processor 500 may be, for example but not limited to, a CPU, or other general-purpose or specific-purpose programmable MCUs, a microprocessor, a DSP, a programmable controller, an ASIC, a GPU, an ALU, a CPLD, a FPGA, or any other kinds of integrated circuits, state machines, or processors based on the ARM, or other similar components or combinations of the above. Alternatively, the processor the first processor 511 and the second processor 500 may be a hardware circuit designed and realized using an HDL or any other digital circuits well known to those skilled in the art.

Please refer to FIGS. 7A-7D together with the flow chart in FIG. 6. The projection method in FIG. 6 may be executed by the projection system 5 in FIG. 5. The projection method in FIG. 6 includes steps S61-S63. In step S61, the projection system 5 may take the first image 71 of the target area by the camera 510 of the projection device 51, wherein the first image 71 includes the depth information of the foreground object 71A and the background object 71B in the target area. In step S62, the projection system 5 may obtain and analyze the first image 71 by the first processor 511 of the projection device 51, and obtain the foreground contour 72 corresponding to the foreground object 71A according to the depth information of the first image 71. In step S63, the projection system 5 may overlay the selected pattern 72A onto the foreground contour 72 to generate the second image 73 by the electronic device 50, and provide the second image 73 to the projection device 51, so that the projection device 51 projects the second image 73 to the target area.

In the following contents related to the projection method in FIG. 6 being executed by the projection system 5, please refer to the schematic diagrams in FIGS. 7A to 7D to better understand the operation details of the projection method.

The operation of step S61 will be explained together with the contents in relations with FIG. 7A. First, in step S61, the camera 510 of the projection device 5 may capture the first image 71 of the target area. The first image 71 captured by the camera 510 includes the depth information of all objects, including the foreground object 71A and the background object 71B, in the target area.

The operation of step S62 will be explained together with the content in relation with FIG. 7B. In step S62, the first image 71 captured by the camera 510 of the projection device 5 will be provided to the first processor 511, allowing the first processor 511 to analyze the depth information of the first image 71, and to accordingly remove background of the first image 71, such that the background object 71B in the first image 71 is removed and the foreground contour 72 corresponding to the foreground object 71A as shown in FIG. 7B is obtained.

The operation of step S63 will be explained together with the contents in relation with FIGS. 7C and 7D. In step S63, the foreground contour 72 obtained by the first processor 511 will be provided to the second processor 500 of the electronic device 50, and the second processor 500 may determine the selected pattern by executing the application. In some embodiments, the electronic device 50 may store the plurality of patterns for selection, and the electronic device 50 may select, using a user input received or automatically, one from the patterns for selection and use the selected one as the selected pattern (such as the selected pattern 72A in FIG. 7C). The electronic device 50 may adaptively adjust the selected pattern to a same size of the foreground contour 72 according to the size of the coordinate trajectory of the foreground contour 72 as shown in FIG. 7C, and then overlay the selected pattern 72A onto the foreground contour 72 to generate the second image 73 as shown in FIG. 7D. The electronic device 50 also provides the user with a preview of the image in which the selected pattern 72A is overlaid onto the foreground contour 72.

In some embodiments, the projection system 5 provides a function to the user that they may adjust, such as the selected pattern 72A in FIG. 7C, by operating the electronic device 50. Specifically, the screen of the electronic device 50 may display the second image (for example, the second image 73 in FIG. 7D), which is projected by the projection device 51 at the same time, and the selected pattern 72A is overlaid onto the foreground contour 72 of the second image. In this way, the user controls the electronic device 50 to perform adjustment of the selected pattern 72A (such as scaling, adjusting position, adjusting transparency, adjusting color, etc.). At that time, the selected pattern in second image 73 will also be updated on the second image 73 projected by projection device 51, providing visual feedback for the users in real-time.

Please refer to FIG. 7D again. After the user determines the selected pattern and its settings, the second image 73 will be projected to the target area through the projection device 51 as shown in FIG. 7D. Although not illustrated in FIG. 7D, in some embodiments, the second processor 500 overlays the foreground contour 72 on the selected background (not illustrated) before the second processor 500 overlays the selected pattern 72A onto the foreground contour 72 to generate the second image 73 as shown in FIG. 7D. Then, the selected pattern 72A is overlaid onto the foreground contour 72 to generate the overlaid second image 73. Whether the selected background 341 should be presented in the second image 73 or not may be selected by the user, which is similar to the implementation in relation with the FIGS. 3A to 3D above, and details will not be described herein.

In summary, the electronic device, the projection system, and projection method of the present disclosure allow the users to conveniently determine the foreground contour corresponding to the foreground object in the target area to be projected by executing the application. The visual feedbacks are provided when the users are adjusting the selected objects, enabling different selected objects to be accurately projected on the foreground object, generating various visual effects. In this way, the electronic device, the projection system and the projection method of the present disclosure may improve conventional projectors in convenience and accuracy when performing light mapping projection operations, and effectively improves the three-dimensional effect of the selected pattern projected on the foreground object.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An electronic device, communicatively coupled to a projection device, the electronic device comprising a camera, a memory and a processor, wherein:
the memory stores an application; and
the processor is coupled to the camera and the memory, the processor is configured to execute the following steps of the application:
controlling the projection device to project a marked image having a plurality of predetermined marks to a target area;
controlling the camera to take a first image of the target area, wherein the first image comprises a foreground object and a background object in the target area;
analyzing the first image to obtain a foreground contour corresponding to the foreground object; and
overlaying a selected pattern onto the foreground contour to generate a second image, and controlling the projection device to project the second image to the target area.

2. The electronic device of claim 1, wherein the plurality of predetermined marks are respectively distributed at least two corner positions of the marked image.

3. The electronic device of claim 1, wherein the first image comprises the complete marked image projected to the target area.

4. The electronic device of claim 1, wherein the processor obtains the foreground contour corresponding to the foreground object of the first image by removing the background object from the first image.

5. The electronic device of claim 1, wherein the processor is configured to execute the following steps:
determining a plurality of positions of the plurality of predetermined marks in the first image, and determining a projection range of the marked image projected to the target area according to the plurality of positions; and
calculating a relative relationship information of the foreground contour and the marked image in the first image according to the projection range and the foreground contour.

6. The electronic device of claim 5, wherein the processor further scales the selected pattern according to the relative relationship information of the foreground contour and the marked image in the first image, allowing a size of the scaled selected pattern to match a size of the foreground contour.

7. The electronic device of claim 5, wherein before the processor overlays the selected pattern onto the foreground contour to generate the second image, the processor is further configured to execute the following steps:
providing a selected background, overlaying the foreground contour onto the selected background; and
according to the relative relationship information, overlaying the scaled selected pattern at a position of the foreground contour to generate the second image.

8. The electronic device of claim 7, wherein the selected pattern and the selected background are stored in the memory of the electronic device or are downloaded from a cloud server to the memory of the electronic device.

9. The electronic device of claim 1, wherein the plurality of predetermined marks are a plurality of QR codes.

10. A projection system, comprising projection device and electronic device, wherein:
the projection device comprises a camera and a first processor, wherein:
the camera takes a first image of the target area, wherein the first image comprises a depth information of a foreground object and a background object in the target area; and
the first processor is configured to receive the first image, and obtain a foreground contour corresponding to the foreground object through analyzing the depth information of the first image;
the electronic device is communicatively coupled to the projection device, the electronic device comprises a second processor, and configured to execute:
overlaying a selected pattern onto the foreground contour to generate a second image, and providing the second image to the projection device, allowing the projection device to project the second image to the target area.

11. The projection system of claim 10, wherein the first processor removes the background object in the first image according to the depth information of the first image, thereby obtaining the foreground contour corresponding to the foreground object in the first image.

12. The projection system of claim 10, wherein the first processor is configured to execute the following steps:
according to the depth information and the foreground contour of the first image, calculating a relative relationship information of the foreground contour in the first image.

13. The projection system of claim 12, wherein the second processor further scales the selected pattern according to the relative relationship information of the foreground contour in the first image, allowing a size of the scaled selected pattern matches a size of the foreground contour.

14. The projection system of claim 12, wherein before the second processor overlays the selected pattern onto the foreground contour to generate the second image, the second processor is further configured to execute the following steps:
providing a selected background, overlaying the foreground contour onto the selected background; and
according to the relative relationship information, overlaying the scaled selected pattern on a position of the foreground contour to generate the second image.

15. The projection system of claim 14, wherein the selected pattern and the selected background are stored in the projection device or the electronic device, or the selected pattern and the selected background are downloaded from a cloud server to the projection device or the electronic device.

16. A projection method, configured to control a projection device, the projection method comprising:
controlling the projection device to project a marked image having a plurality of predetermined marks to a target area;
taking a first image of the target area, wherein the first image comprises a foreground object and a background object in the target area;
analyzing the first image to obtain a foreground contour corresponding to the foreground object; and
overlaying a selected pattern onto the foreground contour to generate a second image, and controlling the projection device to project the second image to the target area.

17. The projection method of claim 16, wherein the plurality of predetermined marks are respectively distributed at least two corner positions of the marked image.

18. The projection method of claim 16, wherein the first image comprises the complete marked image projected to the target area.

19. The projection method of claim 16, wherein the foreground contour corresponding to the foreground object in the first image is obtained by removing the background object in the first image.

20. The projection method of claim 16, comprising:
determining a plurality of positions of the plurality of predetermined marks in the first image, and determining a projection range of the marked image projected to the target area according to the plurality of positions; and
calculating a relative relationship information of the foreground contour and the marked image in the first image according to the projection range and the foreground contour.

21. The projection method of claim 20, further comprising:
scaling the selected pattern according to the relative relationship information of the foreground contour and the marked image in the first image, allowing a size of the scaled selected pattern matches a size of the foreground contour.

22. The projection method of claim 20, wherein before overlaying the selected pattern onto the foreground contour to generate the second image, the projection method further comprises the following steps:
providing a selected background, and overlaying the foreground contour onto the selected background; and
according to the relative relationship information, overlaying the scaled selected pattern on a position of the foreground contour to generate the second image.

23. The projection method of claim 16, wherein the plurality of predetermined marks are a plurality of QR codes.

24. A projection method, configured to control a projection system, wherein the projection system comprises a projection device and an electronic device, the projection device comprises a camera and a first processor, the projection method comprises:
taking a first image of the target area through the camera of the projection device, wherein the first image comprises a depth information of a foreground object and a background object in the target area;
obtaining and analyzing the first image through the first processor, to obtain a foreground contour corresponding to the foreground object according to the depth information of the first image; and
overlaying a selected pattern onto the foreground contour to generate a second image through the electronic device, and providing the second image to the projection device, allowing the projection device to project the second image to the target area.

25. The projection method of claim 24, wherein the foreground contour corresponding to the foreground object in the first image is obtained by the first processor removing the background object from the first image according to the depth information of the first image.

26. The projection method of claim 24, comprising:
through the first processor, calculating a relative relationship information of the foreground contour in the first image according to the depth information of the first image and the foreground contour.

27. The projection method of claim 26, further comprising:
scaling the selected pattern according to the relative relationship information of the foreground contour in the first image, allowing a size of the scaled selected pattern to match a size of the foreground contour.

28. The projection method of claim 26, wherein before overlaying the selected pattern onto the foreground contour to generate the second image, the projection method further comprises the following steps:
providing a selected background, and overlaying the foreground contour onto the selected background; and
according to the relative relationship information, overlaying the scaled selected pattern on a position of the foreground contour to generate the second image.
